(19) United States
(12) Patent Application Publication
(10) Pub. No.: US 2026/0184384 A1
(43) Pub. Date: Jul. 2, 2026

(54) VEHICLE BODY LOWER STRUCTURE

(71) Applicant: Honda Motor Co., Ltd., Tokyo (JP)

(72) Inventor: Hiroto SUGIYAMA, Saitama (JP)

(73) Assignee: Honda Motor Co., Ltd., Tokyo (JP)

(21) Appl. No.: 19/435,639

(22) Filed: Dec. 29, 2025

(30) Foreign Application Priority Data
Dec. 30, 2024 (CN) 202411969180.4

(51) Int. Cl. B62D 25/20; B60K 1/04

(52) U.S. Cl. CPC B62D 25/2081; B60K 1/04; B62D 25/2072; B60K 2001/0438

(57) ABSTRACT

A vehicle body lower structure disposed in a vehicle is provided. The vehicle body lower structure includes: a jack-up member, the jack-up member having at a lower end thereof a jack receiving portion; a cover member, covering a lower side of a vehicle body of the vehicle from a lower side of the vehicle; and a seal, disposed at an upper side of the jack receiving portion and contacting the jack-up member. In the vehicle body lower structure of the disclosure, since the jack receiving portion of the jack-up member is not covered by the cover member and is exposed to an exterior of the vehicle, a jack-up operation may be easily performed, and through a structure of the seal in contact with the jack-up member, water penetration into the cover member may be prevented.

### CROSS-REFERENCE TO RELATED APPLICATION

This application claims the priority benefit of China application serial no. 202411969180.4, filed on Dec. 30, 2024. The entirety of the above-mentioned patent application is hereby incorporated by reference herein and made a part of this specification.

### BACKGROUND

### Technical Field

The disclosure relates to a vehicle body lower structure, and more particularly to a vehicle body lower structure that may prevent water from splashing onto a battery disposed at a lower side of a vehicle body floor while simultaneously maintaining operability during a jack-up operation.

### Description of Related Art

Patent Document 1 (Japanese Patent Application Laid-Open No. 2012-162102) describes a vehicle chassis having an opening formed thereon, in which the opening exposes a jack-up portion, and the jack-up operation is performed through the jack-up portion.

Patent Document 2 (Japanese Utility Model Application Laid-Open No. 61-119877) describes a side sill cover of a vehicle, the side sill cover having a cover disposed at a jack-up operation point.

### SUMMARY

Electric vehicles are usually configured with large batteries, and the batteries may be disposed on the lower surface of the vehicle body floor. At this time, water can easily splash onto the bolts for fixing the batteries, and in the worst scenario, the bolts may fall off due to rust, resulting in battery damage and rendering the electric vehicle inoperable. Therefore, a structure for preventing water from splashing onto the fixing portions of the battery is required.

In the chassis of Patent Document 1 (Japanese Patent Application Laid-Open No. 2012-162102), since the jack-up portion is exposed through the opening, the jack-up operation may be performed easily, but Patent Document 1 (Japanese Patent Application Laid-Open No. 2012-162102) has the problem that water enters into a vehicle body interior through the opening.

In the side sill cover of Patent Document 2 (Japanese Utility Model Application Laid-Open No. 61-119877), a cover is disposed to cover the jack-up operation point so as to prevent water from entering into the vehicle body interior, but each time the jack-up operation is performed, the cover removal and installation operations must be performed, resulting in poor operability.

In order to solve the problem, the disclosure provides a vehicle body lower structure that may prevent water from splashing onto the battery disposed at a lower side of the vehicle body floor, while simultaneously maintaining operability during the jack-up operation.

In order to achieve the purpose, according to the technical solution of an embodiment of the disclosure, the disclosure provides a vehicle body lower structure disposed in a vehicle, in which the vehicle body lower structure includes: a jack-up member, the jack-up member having at a lower end thereof a jack receiving portion; a cover member, covering a lower side of a vehicle body of the vehicle from a lower side of the vehicle; and a seal, disposed at an upper side of the jack receiving portion and contacting the jack-up member.

In the vehicle body lower structure of the embodiment of the disclosure, a cover member is additionally provided at the upper side of the jack receiving portion of the jack-up member, and a seal is also additionally provided. Since the jack receiving portion of the jack-up member is not covered by the cover member and is exposed to the exterior of the vehicle, the jack-up operation may be easily performed, and through the structure of the seal in contact with the jack-up member, water may be prevented from penetrating into the cover member. The vehicle body lower structure of the disclosure may prevent water from splashing onto the battery disposed at a lower side of the vehicle body floor, while simultaneously maintaining operability during the jack-up operation.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic diagram of a vehicle according to an embodiment of the disclosure.

FIG. 2 is a schematic diagram of a vehicle body lower structure according to an embodiment of the disclosure.

FIG. 3 is a cross-sectional schematic diagram along line C-C of FIG. 2.

FIG. 4 is an enlarged schematic diagram of an area A of the vehicle body lower structure of FIG. 3.

FIG. 5 is a perspective schematic diagram of a vehicle body lower structure according to an embodiment of the disclosure.

FIG. 6A is a schematic diagram of a cover member of a vehicle body lower structure with a seal installed according to an embodiment of the disclosure.

FIG. 6B is a cross-sectional schematic diagram along line D-D of FIG. 6A.

FIG. 6C is a cross-sectional schematic diagram along line E-E of FIG. 6A.

FIG. 7 is a perspective schematic diagram of reinforcing ribs of a jack-up member of a vehicle body lower structure according to an embodiment of the disclosure.

FIG. 8 is a cross-sectional schematic diagram of an inner cover member, a jack-up member, and an outer cover member of a vehicle body lower structure according to an embodiment of the disclosure.

FIG. 9 is a schematic diagram of a vehicle body lower structure according to an embodiment of the disclosure.

FIG. 10 is a schematic diagram of a vehicle body lower structure according to an embodiment of the disclosure.

FIG. 11A is a schematic diagram of a cover member of a vehicle body lower structure according to an embodiment of the disclosure.

FIG. 11B is a cross-sectional schematic diagram along line F-F of FIG. 11A.

### DESCRIPTION OF THE EMBODIMENTS

Reference will now be made in detail to the exemplary embodiments of the disclosure, examples of the exemplary embodiments are illustrated in the accompanying drawings. Whenever possible, the same reference numerals are used in the drawings and description to refer to the same or similar parts.

Since the jack receiving portion of the jack-up member is not covered by the cover member and is exposed to an exterior of the vehicle, the jack-up operation may be easily performed, and through a structure of the seal in contact with the jack-up member, water may be prevented from penetrating into the cover member.

In an embodiment of the disclosure, the seal includes: an upper flange extending along an upper surface of the cover member; and a lower flange extending along a lower surface of the cover member, in which the upper flange and the lower flange are installed by sandwiching the cover member.

The seal is installed to sandwich the cover member between the upper flange and the lower flange, such that water may be more reliably prevented from entering the gap between the seal and the cover member, and the seal may be firmly installed on the cover member, preventing curling or detachment of the seal caused by wind pressure and water.

In an embodiment of the disclosure, the seal includes: an inner seal contacting the jack-up member from an inner side of the vehicle; and an outer seal contacting the jack-up member from an outer side of the vehicle.

Through the inner seal and the outer seal, an inner surface and an outer surface of the jack-up member may be effectively sealed, such that water entry may be more reliably prevented.

In an embodiment of the disclosure, the cover member includes: an inner cover member disposed with the inner seal; and an outer cover member disposed with the outer seal.

Since the inner cover member and the outer cover member are disposed, assembly may become easy even with a structure that performs sealing from the inside and outside.

In an embodiment of the disclosure, the cover member has a seal receiving flange. At an end of the seal, the seal receiving flange contacts a lower surface of the seal.

Even at the end of the seal, the seal receiving flange may prevent formation of a gap between the seal and the cover member, thereby enabling suppression of water entry.

In an embodiment of the disclosure, the inner cover member has a seal receiving flange. At the end of the seal, the seal receiving flange contacts the lower surface of the seal. The seal receiving flange is disposed within a range where the seal receiving flange contacts a lower surface of the seal of the inner cover member and contacts a lower surface of the seal of the outer cover member.

Even with a structure that sandwiches the jack-up member between the inner cover member and the outer cover member, the seal is disposed through the seal receiving flange, such that at the end of the seal, a gap will not be generated between the seal and the cover member, thereby enabling suppression of water entry.

In an embodiment of the disclosure, the seal extends in a horizontal direction of the vehicle and contacts the jack-up member.

Since the seal extends in the horizontal direction of the vehicle and contacts the jack-up member, the cover member may be formed to be flat, and water entry may be suppressed without compromising aerodynamic performance.

In an embodiment of the disclosure, the jack-up member has a reinforcing rib. The reinforcing rib extends from the jack receiving portion toward an upper side of the vehicle and protrudes toward the cover member. The cover member has a recess corresponding to the reinforcing rib.

Even when the reinforcing rib is disposed on the jack-up member, due to the structure of the recess, a seamless contact with the seal may be achieved.

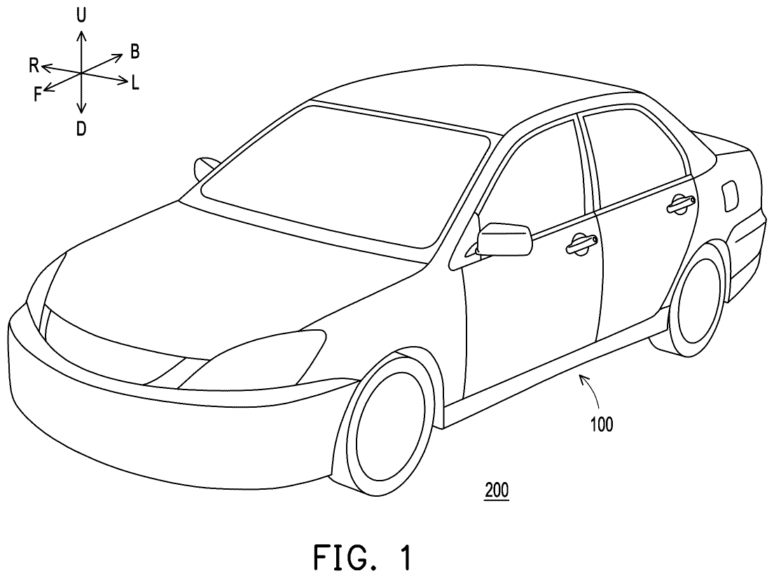

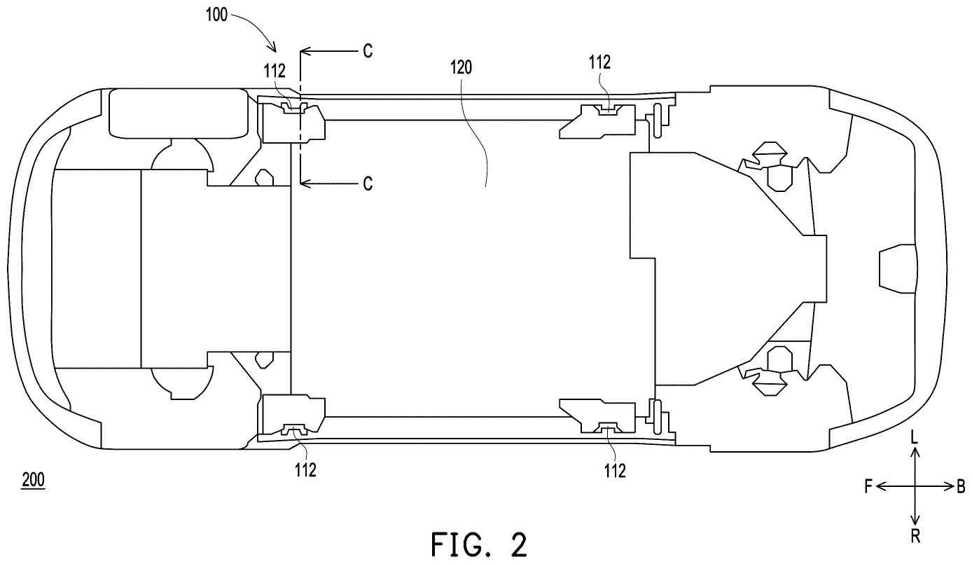

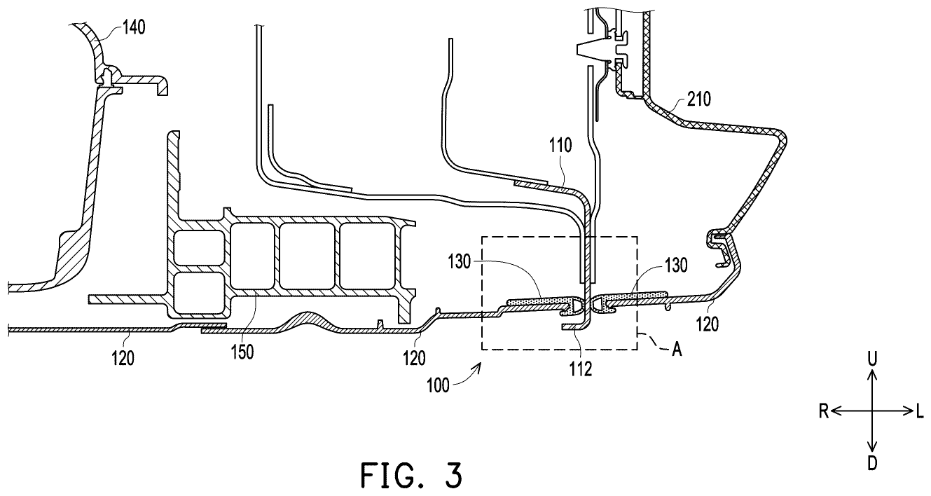

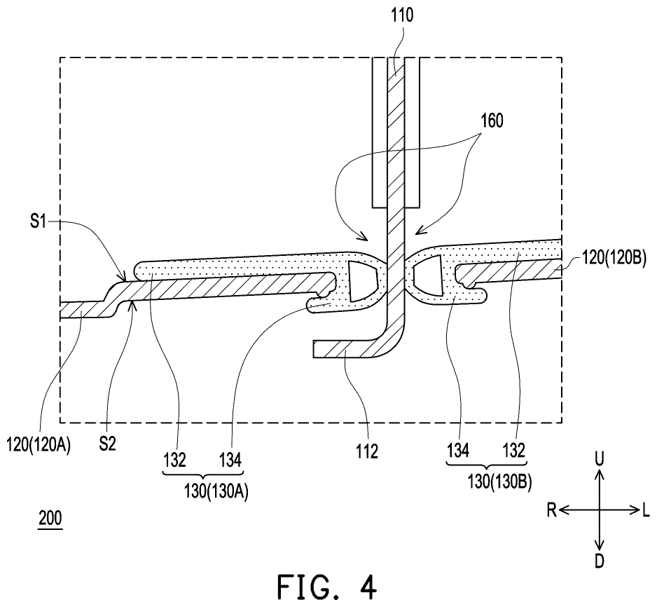

FIG. 1 is a schematic diagram of a vehicle according to an embodiment of the disclosure. FIG. 2 is a schematic diagram of a vehicle body lower structure according to an embodiment of the disclosure. FIG. 3 is a cross-sectional schematic diagram along line C-C of FIG. 2. FIG. 4 is an enlarged schematic diagram of an area A of the vehicle body lower structure of FIG. 3.

Referring to FIG. 1, FIG. 1 shows an upper side U, a lower side D, a front side F, a rear side B, a left side L and a right side R of a vehicle 200. A vehicle body lower structure 100 is disposed at the lower side D of the vehicle 200.

Referring to FIG. 1 to FIG. 4, the vehicle body lower structure 100 is disposed in the vehicle 200. As shown in FIG. 3, the vehicle body lower structure 100 includes: a jack-up member 110, the jack-up member 110 having at a lower end thereof a jack receiving portion 112; a cover member 120, covering a lower side of a vehicle body 210 of the vehicle 200 from the lower side D of vehicle 200; and a seal 130, disposed at the upper side U of the jack receiving portion 112, and contacting the jack-up member 110.

Since the jack receiving portion 112 of the jack-up member 110 is not covered by the cover member 120 and is exposed to an exterior of the vehicle 200, the jack-up operation may be easily performed, and through a structure of the seal 130 in contact with the jack-up member 110, water may be prevented from penetrating into the cover member 120.

Referring to FIG. 3, along the right side R to the left side L of the vehicle 200, three cover members 120 may be sequentially disposed, which are respectively: the cover member 120 for battery, the cover member 120 for jack-up member, and the cover member 120 for side sill cover. FIG. 3 also shows a battery 140 and a battery fixing portion 150.

Referring to FIG. 4, the seal 130 may include: an upper flange 132, extending along an upper surface S1 of the cover member 120; and a lower flange 134, extending along a lower surface S2 of the cover member 120. The upper flange 132 and the lower flange 134 are installed by sandwiching the cover member 120.

The seal 130 is installed to sandwich the cover member 120 between the upper flange 132 and the lower flange 134, such that water may be more reliably prevented from entering from the gap between the seal 130 and the cover member 120, and the seal 130 may be firmly installed on the cover member 120, preventing curling or detachment of the seal 130 caused by wind pressure and water.

Referring to FIG. 4, the seal 130 may extend in a horizontal direction L-R of the vehicle 200 and contact the jack-up member 110. Since the seal 130 extends in the horizontal direction L-R of vehicle 200 and contacts the jack-up member 110, a flat cover member 120 may be formed, and water entry may be suppressed without compromising aerodynamic performance.

Referring to FIG. 4, the seal 130 may include: an inner seal 130A, contacting the jack-up member 110 from the inner side of the vehicle 200 (right side R in FIG. 4); and an outer seal 130B, contacting the jack-up member 110 from the outer side of the vehicle 200 (left side L in FIG. 4).

As shown in FIG. 4, the inner seal 130A and the outer seal 130B contact the jack-up member 110, forming contact portions 160 on both sides. Through the inner seal 130A and the outer seal 130B, an inner surface and an outer surface of the jack-up member 110 may be effectively sealed, such that water entry may be more reliably prevented.

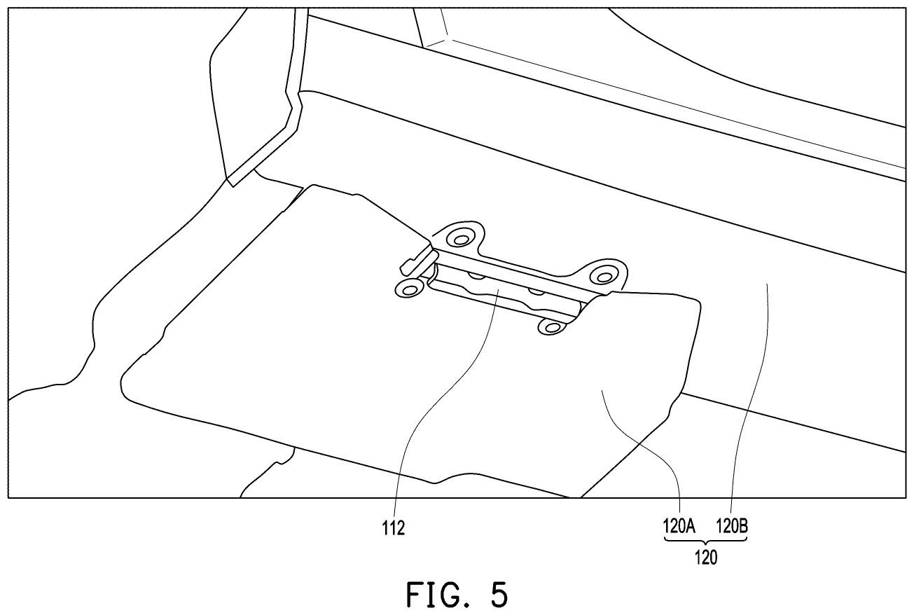

FIG. 5 is a perspective schematic diagram of a vehicle body lower structure according to an embodiment of the disclosure. Referring to FIG. 5 and FIG. 4, the cover member 120 may include: an inner cover member 120A, disposed with the inner seal 130A (as shown in FIG. 4); and an outer cover member 120B, disposed with outer seal 130B (as shown in FIG. 4).

Since the inner cover member 120A and the outer cover member 120B are disposed, assembly may become easy even with a structure that performs sealing from the inside and outside.

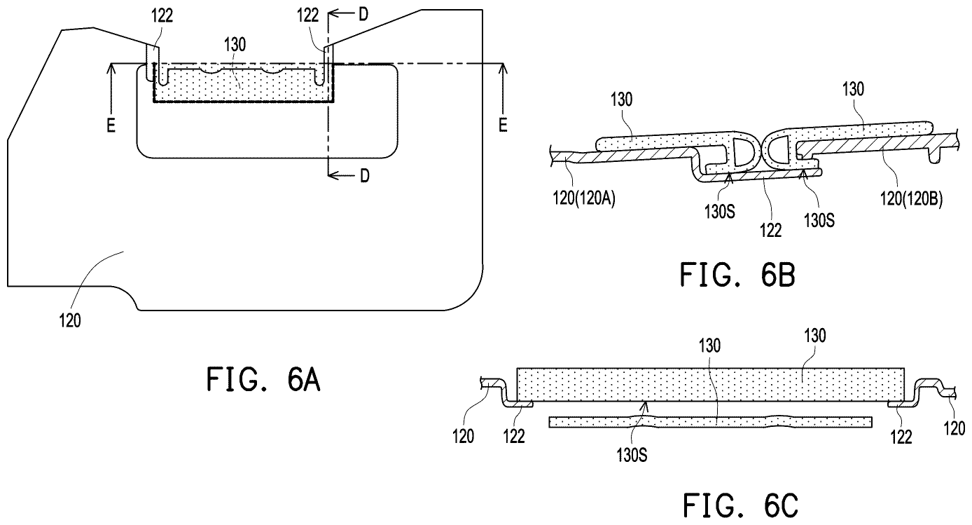

FIG. 6A is a schematic diagram of a cover member of a vehicle body lower structure with a seal installed according to an embodiment of the disclosure. FIG. 6B is a cross-sectional schematic diagram along line D-D of FIG. 6A. FIG. 6C is a cross-sectional schematic diagram along line E-E of FIG. 6A.

Referring to FIG. 6A to FIG. 6C, the cover member 120 may have a seal receiving flange 122. At an end of the seal 130, the seal receiving flange 122 contacts a lower surface 130S of the seal 130.

Even at the end of the seal 130, the seal receiving flange 122 may prevent formation of a gap between the seal 130 and the cover member 120, thereby enabling suppression of water entry.

The cover member 120 may include the inner cover member 120A and the outer cover member 120B. In an embodiment of the disclosure, as shown in FIG. 6B, the inner cover member 120A may have the seal receiving flange 122. At the end of the seal 130, the seal receiving flange 122 contacts the lower surface 130S of the seal 130. The seal receiving flange 122 is disposed within a range where the seal receiving flange 122 contacts the lower surface 130S of the seal 130 of the inner cover member 120A and contacts the lower surface 130S of the seal 130 of the outer cover member 120B.

Even with a structure that sandwiches the jack-up member 110 between the inner cover member 120A and the outer cover member 120B, the seal 130 is disposed through the seal receiving flange 122, such that at the end of the seal 130, a gap will not be generated between the seal 130 and the cover member 120, thereby enabling suppression of water entry.

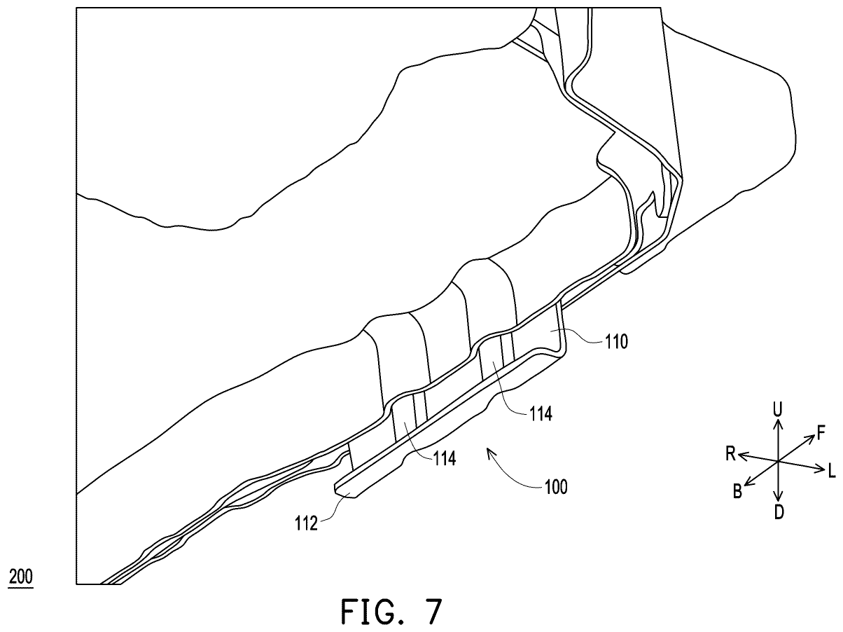

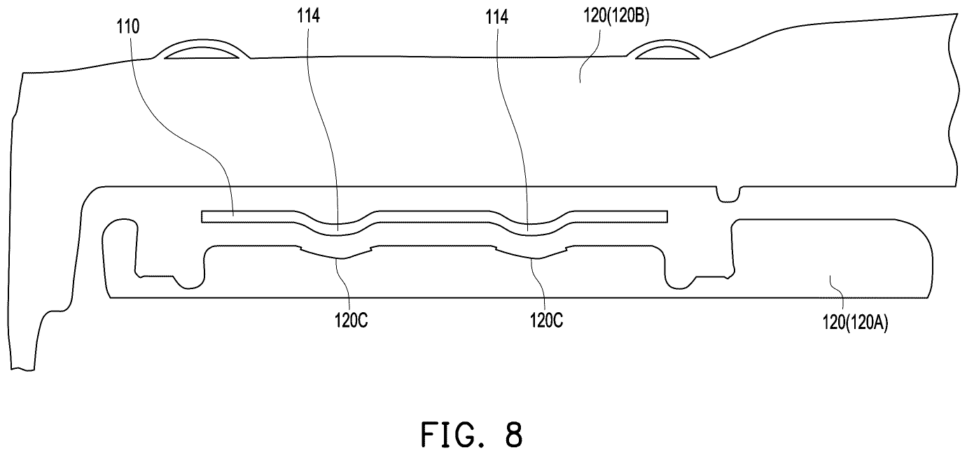

FIG. 7 is a perspective schematic diagram of reinforcing ribs of a jack-up member in a vehicle body lower structure according to an embodiment of the disclosure. FIG. 8 is a cross-sectional schematic diagram of an inner cover member, a jack-up member, and an outer cover member of a vehicle body lower structure according to an embodiment of the disclosure.

Referring to FIG. 7 to FIG. 8, the jack-up member 110 may have a reinforcing rib 114. The reinforcing rib 114 extends from the jack receiving portion 112 toward the upper side U of the vehicle 200 and protrudes toward the cover member 120 (inner cover member 120A as shown in FIG. 8). The cover member 120 has a recess 120C corresponding to the reinforcing rib 114.

Even when the reinforcing rib 114 is disposed on the jack-up member 110, due to the structure of the recess 120C, a seamless contact with the seal 130 may be achieved.

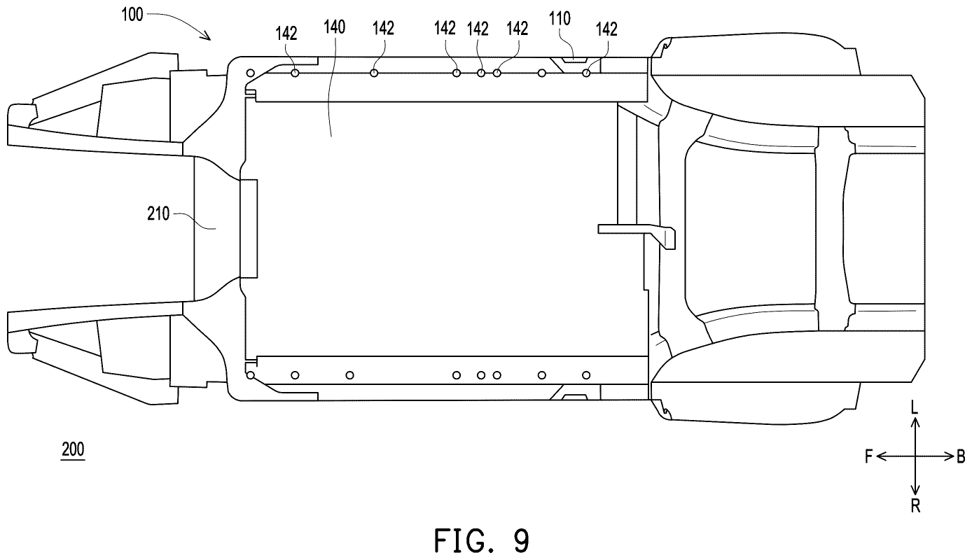

FIG. 9 is a schematic diagram of a vehicle body lower structure according to an embodiment of the disclosure. Referring to FIG. 9, in the vehicle body lower structure 100 of the embodiment, compared to FIG. 2, the cover member 120 is removed and the battery 140 is exposed. The battery 140 is fixed on the vehicle body 210 through multiple battery fixing bolts 142. As shown in FIG. 9, the setting position of the battery fixing bolts 142 is more toward the inner side of the vehicle 200 (right side R as shown in FIG. 9) than the setting position of the jack-up member 110.

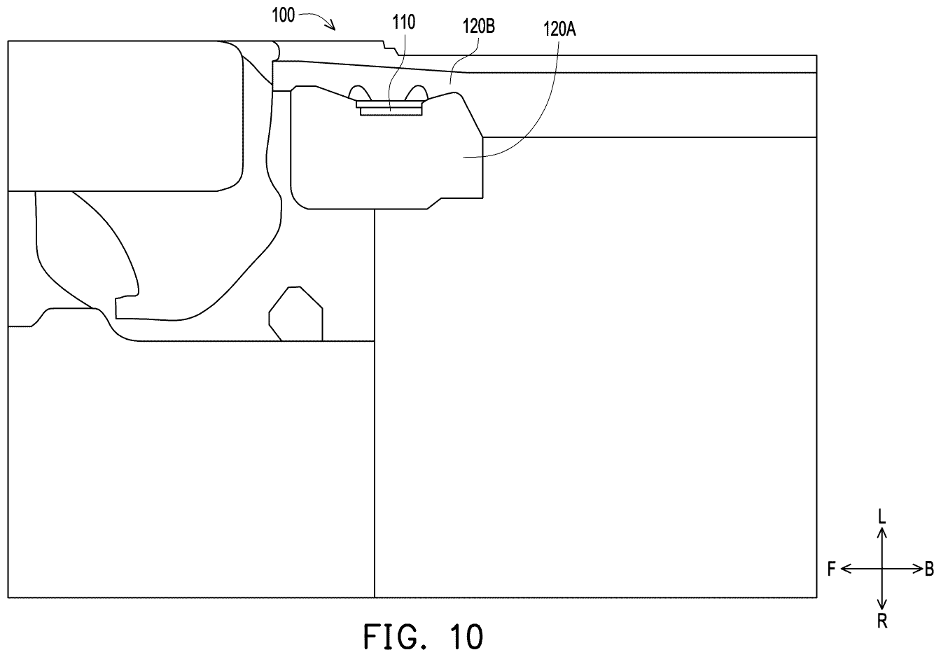

FIG. 10 is a schematic diagram of a vehicle body lower structure according to an embodiment of the disclosure. Referring to FIG. 10, in the vehicle body lower structure 100 of the embodiment, the inner cover member 120A and the outer cover member 120B only cover a surrounding area of the jack-up member 110, such that the jack-up member 110 may be assembled more easily.

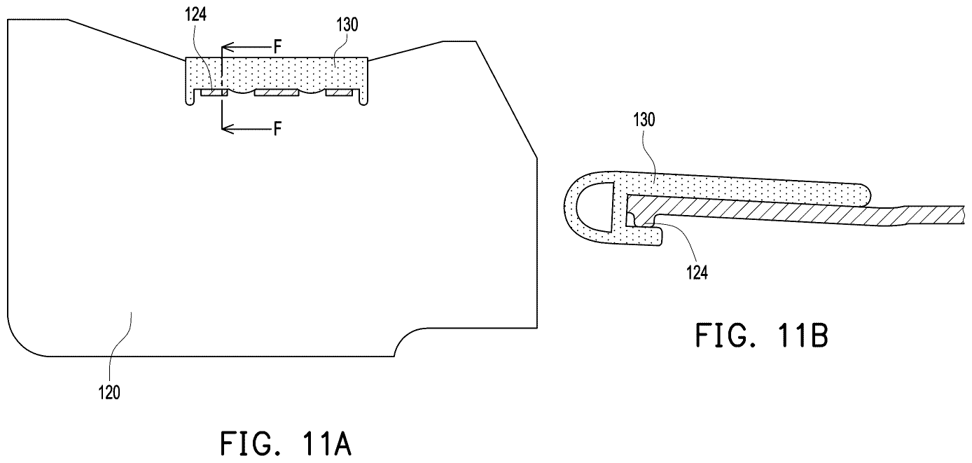

FIG. 11A is a schematic diagram of a cover member of a vehicle body lower structure according to an embodiment of the disclosure. FIG. 11B is a cross-sectional schematic diagram along line F-F of FIG. 11A. Referring to FIG. 11A to FIG. 11B, the cover member 120 may include a height adjustment rib 124 for adjusting a height of the seal 130.

In summary, the vehicle body lower structure of the disclosure has at least the following technical effects:

A cover member is additionally provided at the upper side of the jack receiving portion of the jack-up member, and a seal is also additionally provided. Since the jack receiving portion of the jack-up member is not covered by the cover member and is exposed to the exterior of the vehicle, the jack-up operation may be easily performed, and through the structure of the seal in contact with the jack-up member, water may be prevented from penetrating into the cover member. The vehicle body lower structure of the disclosure may prevent water from splashing onto the battery disposed at the lower side of the vehicle body floor, while simultaneously maintaining operability during the jack-up operation.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. A vehicle body lower structure, disposed in a vehicle, wherein the vehicle body lower structure comprises:
a jack-up member, the jack-up member having at a lower end thereof a jack receiving portion;
a cover member, covering a lower side of a vehicle body of the vehicle from a lower side of the vehicle; and
a seal, disposed at an upper side of the jack receiving portion, and contacting the jack-up member.

2. The vehicle body lower structure according to claim 1, wherein the seal comprises:
an upper flange, extending along an upper surface of the cover member; and
a lower flange, extending along a lower surface of the cover member,
wherein the upper flange and the lower flange are installed by sandwiching the cover member.

3. The vehicle body lower structure according to claim 1, wherein the seal comprises:
an inner seal, contacting the jack-up member from an inner side of the vehicle; and
an outer seal, contacting the jack-up member from an outer side of the vehicle.

4. The vehicle body lower structure according to claim 3, wherein the cover member comprises:
an inner cover member, disposed with the inner seal; and
an outer cover member, disposed with the outer seal.

5. The vehicle body lower structure according to claim 1, wherein
the cover member has a seal receiving flange, and
at an end of the seal, the seal receiving flange contacts a lower surface of the seal.

6. The vehicle body lower structure according to claim 2, wherein
the cover member has a seal receiving flange, and
at an end of the seal, the seal receiving flange contacts a lower surface of the seal.

7. The vehicle body lower structure according to claim 3, wherein
the cover member has a seal receiving flange, and
at an end of the seal, the seal receiving flange contacts a lower surface of the seal.

8. The vehicle body lower structure according to claim 4, wherein
the inner cover member has a seal receiving flange,
at an end of the seal, the seal receiving flange contacts a lower surface of the seal, and
the seal receiving flange is disposed within a range where the seal receiving flange contacts a lower surface of the seal of the inner cover member and contacts a lower surface of the seal of the outer cover member.

9. The vehicle body lower structure according to claim 1, wherein
the seal extends in a horizontal direction of the vehicle and contacts the jack-up member.

10. The vehicle body lower structure according to claim 1, wherein
the jack-up member has a reinforcing rib,
the reinforcing rib extends from the jack receiving portion toward an upper side of the vehicle and protrudes toward the cover member, and
the cover member has a recess corresponding to the reinforcing rib.
